(19) United States
(12) Patent Application Publication
(10) Pub. No.: US 2026/0361494 A1
(43) Pub. Date: Nov. 12, 2026

(54) METHOD, APPARATUS AND COMPUTER PROGRAM FOR RECEIVING A TRACKING REFERENCE SIGNAL

(71) Applicant: Nokia Technologies Oy, Espoo (FI)

(72) Inventors: Sami-Jukka Hakola, Kempele (FI); Juha Pekka Karjalainen, Sotkamo (FI); Jorma Johannes Kaikkonen, Oulu (FI); Timo KOSKELA, Oulu (FI)

(73) Assignee: Nokia Technologies Oy, Espoo (FI)

(21) Appl. No.: 19/487,157

(22) PCT Filed: May 26, 2023
(86) PCT No.: PCT/EP2023/064264

§ 371 Date: Nov. 24, 2025

(51) Int. Cl. H04L 5/00; H04W 56/00

(52) U.S. Cl. CPC H04L 5/0051; H04W 56/001

(57) ABSTRACT

There is provided an apparatus comprising means for: receiving, from a network node, a tracking reference signal comprising a first reference signal for a first channel and a second reference signal for a second channel, wherein the first channel is different to the second channel.

### FIELD

The present application relates to a method, apparatus, system and computer program and in particular but not exclusively to the transmission and reception of tracking reference signals.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: receiving, from a network node, a tracking reference signal comprising a first reference signal for a first channel and a second reference signal for a second channel, wherein the first channel is different to the second channel.

The means may be further for: receiving, from the network node, a synchronization signal associated with the first reference signal.

The means may be further for: determining a precoding applied to the synchronization signal; determining that the precoding applied to the synchronization signal is also applied to the first reference signal; and receiving the first reference signal based on the determined precoding.

The means may be further for: determining one or more channel parameters associated with the synchronization signal; and receiving the first reference signal based on the determined one or more channel parameters.

The means may be further for: determining that the first reference signal and the second reference signal have a quasi co-location relation with the synchronization signal; and receiving the first reference signal and the second reference signal based on the determined quasi co-location relation.

The means may be further for: determining that the precoding applied to the first reference signal is also applied to the second reference signal; and receiving the second reference signal based on the determined precoding.

The means may be further for: receiving, from the network node, information indicating one or more first configurations for the first reference signal and one or more second configurations for the second reference signal; receiving, from the network node, information indicating one or more activated tracking reference signal resource sets, wherein each tracking reference signal resource set corresponds to a combination of one of the one or more first configurations for the first reference signal and one of the one or more second configurations for the second reference signal, wherein receiving the tracking reference signal is based on the information indicating the one or more activated tracking reference signal resource sets.

The first reference signal and the second reference signal may be in the same time slot. The first reference signal and the second reference signal may have the same subcarrier allocation. The first reference signal and the second reference signal may have the same bandwidth. The first reference signal and the control channel may utilize a common search space. A bandwidth of the first reference signal may be based on a control resource set associated with the common search space. The first channel may be used to assign the second channel. The second channel may comprise broadcast information and/or system information. The first reference signal may comprise a first demodulation reference signal. The second reference signal may comprise a second demodulation reference signal. The first channel may comprise a control channel. The second channel may comprise a data channel.

According to an aspect, there is provided an apparatus comprising means for: transmitting, to a user equipment, a tracking reference signal comprising a first reference signal for a first channel and a second reference signal for a second channel, wherein the first channel is different to the second channel.

The means may be further for: transmitting, to the user equipment, a synchronization signal associated with the first reference signal.

The means may be further for: transmitting, to the user equipment, information indicating one or more first configurations for the first reference signal and one or more second configurations for the second reference signal; transmitting, to the user equipment, information indicating one or more activated tracking reference signal resource sets, wherein each tracking reference signal resource set corresponds to a combination of one of the one or more first configurations for the first reference signal and one of the one or more second configurations for the second reference signal, wherein transmitting the tracking reference signal is based on the information indicating the one or more activated tracking reference signal resource sets.

The first reference signal and the second reference signal may be in the same time slot. The first reference signal and the second reference signal may have the same subcarrier allocation. The first reference signal and the second reference signal may have the same bandwidth. The first reference signal and the control channel may utilize a common search space. A bandwidth of the first reference signal may be based on a control resource set associated with the common search space. The first channel may be used to assign the second channel. The second channel may comprise broadcast information and/or system information. The first reference signal may comprise a first demodulation reference signal. The second reference signal may comprise a second demodulation reference signal. The first channel may comprise a control channel. The second channel may comprise a data channel.

According to an aspect, there is provided an apparatus comprising at least one processor and at least one memory storing instructions that, when executed by the at least one processor, cause the apparatus at least to: receive, from a network node, a tracking reference signal comprising a first reference signal for a first channel and a second reference signal for a second channel, wherein the first channel is different to the second channel.

The at least one processor may further cause the apparatus to: receive, from the network node, a synchronization signal associated with the first reference signal.

The at least one processor may further cause the apparatus to: determine a precoding applied to the synchronization signal; determining that the precoding applied to the synchronization signal is also applied to the first reference signal; and receive the first reference signal based on the determined precoding.

The at least one processor may further cause the apparatus to: determine one or more channel parameters associated with the synchronization signal; and receive the first reference signal based on the determined one or more channel parameters.

The at least one processor may further cause the apparatus to: determine that the first reference signal and the second reference signal have a quasi co-location relation with the synchronization signal; and receive the first reference signal and the second reference signal based on the determined quasi co-location relation.

The at least one processor may further cause the apparatus to: determine that the precoding applied to the first reference signal is also applied to the second reference signal; and receive the second reference signal based on the determined precoding.

The at least one processor may further cause the apparatus to: receive, from the network node, information indicating one or more first configurations for the first reference signal and one or more second configurations for the second reference signal; receive, from the network node, information indicating one or more activated tracking reference signal resource sets, wherein each tracking reference signal resource set corresponds to a combination of one of the one or more first configurations for the first reference signal and one of the one or more second configurations for the second reference signal, wherein the at least one processor may cause the apparatus to receive the tracking reference signal based on the information indicating the one or more activated tracking reference signal resource sets.

The first reference signal and the second reference signal may be in the same time slot. The first reference signal and the second reference signal may have the same subcarrier allocation. The first reference signal and the second reference signal may have the same bandwidth. The first reference signal and the control channel may utilize a common search space. A bandwidth of the first reference signal may be based on a control resource set associated with the common search space. The first channel may be used to assign the second channel. The second channel may comprise broadcast information and/or system information. The first reference signal may comprise a first demodulation reference signal. The second reference signal may comprise a second demodulation reference signal. The first channel may comprise a control channel. The second channel may comprise a data channel.

According to an aspect, there is provided an apparatus comprising at least one processor and at least one memory storing instructions that, when executed by the at least one processor, cause the apparatus at least to: transmitting, to a user equipment, a tracking reference signal comprising a first reference signal for a first channel and a second reference signal for a second channel, wherein the first channel is different to the second channel.

The at least one processor may further cause the apparatus to: transmit, to the user equipment, a synchronization signal associated with the first reference signal.

The at least one processor may further cause the apparatus to: transmit, to the user equipment, information indicating one or more first configurations for the first reference signal and one or more second configurations for the second reference signal; transmit, to the user equipment, information indicating one or more activated tracking reference signal resource sets, wherein each tracking reference signal resource set corresponds to a combination of one of the one or more first configurations for the first reference signal and one of the one or more second configurations for the second reference signal, wherein the at least one processor may cause the apparatus to transmit the tracking reference signal based on the information indicating the one or more activated tracking reference signal resource sets.

The first reference signal and the second reference signal may be in the same time slot. The first reference signal and the second reference signal may have the same subcarrier allocation. The first reference signal and the second reference signal may have the same bandwidth. The first reference signal and the control channel may utilize a common search space. A bandwidth of the first reference signal may be based on a control resource set associated with the common search space. The first channel may be used to assign the second channel. The second channel may comprise broadcast information and/or system information. The first reference signal may comprise a first demodulation reference signal. The second reference signal may comprise a second demodulation reference signal. The first channel may comprise a control channel. The second channel may comprise a data channel.

According to an aspect, there is provided a method comprising: receiving, from a network node, a tracking reference signal comprising a first reference signal for a first channel and a second reference signal for a second channel, wherein the first channel is different to the second channel.

The method may comprise: receiving, from the network node, a synchronization signal associated with the first reference signal.

The method may comprise: determining a precoding applied to the synchronization signal; determining that the precoding applied to the synchronization signal is also applied to the first reference signal; and receiving the first reference signal based on the determined precoding.

The method may comprise: determining one or more channel parameters associated with the synchronization signal; and receiving the first reference signal based on the determined one or more channel parameters.

The method may comprise: determining that the first reference signal and the second reference signal have a quasi co-location relation with the synchronization signal; and receiving the first reference signal and the second reference signal based on the determined quasi co-location relation.

The method may comprise: determining that the precoding applied to the first reference signal is also applied to the second reference signal; and receiving the second reference signal based on the determined precoding.

The method may comprise: receiving, from the network node, information indicating one or more first configurations for the first reference signal and one or more second configurations for the second reference signal; receiving, from the network node, information indicating one or more activated tracking reference signal resource sets, wherein each tracking reference signal resource set corresponds to a combination of one of the one or more first configurations for the first reference signal and one of the one or more second configurations for the second reference signal, wherein receiving the tracking reference signal is based on the information indicating the one or more activated tracking reference signal resource sets.

The first reference signal and the second reference signal may be in the same time slot. The first reference signal and the second reference signal may have the same subcarrier allocation. The first reference signal and the second reference signal may have the same bandwidth. The first reference signal and the control channel may utilize a common search space. A bandwidth of the first reference signal may be based on a control resource set associated with the common search space. The first channel may be used to assign the second channel. The second channel may comprise broadcast information and/or system information. The first reference signal may comprise a first demodulation reference signal. The second reference signal may comprise a second demodulation reference signal. The first channel may comprise a control channel. The second channel may comprise a data channel.

According to an aspect, there is provided a method comprising: transmitting, to a user equipment, a tracking reference signal comprising a first reference signal for a first channel and a second reference signal for a second channel, wherein the first channel is different to the second channel.

The method may comprise: transmitting, to the user equipment, a synchronization signal associated with the first reference signal.

The method may comprise: transmitting, to the user equipment, information indicating one or more first configurations for the first reference signal and one or more second configurations for the second reference signal; transmitting, to the user equipment, information indicating one or more activated tracking reference signal resource sets, wherein each tracking reference signal resource set corresponds to a combination of one of the one or more first configurations for the first reference signal and one of the one or more second configurations for the second reference signal, wherein transmitting the tracking reference signal is based on the information indicating the one or more activated tracking reference signal resource sets.

The first reference signal and the second reference signal may be in the same time slot. The first reference signal and the second reference signal may have the same subcarrier allocation. The first reference signal and the second reference signal may have the same bandwidth. The first reference signal and the control channel may utilize a common search space. A bandwidth of the first reference signal may be based on a control resource set associated with the common search space. The first channel may be used to assign the second channel. The second channel may comprise broadcast information and/or system information. The first reference signal may comprise a first demodulation reference signal. The second reference signal may comprise a second demodulation reference signal. The first channel may comprise a control channel. The second channel may comprise a data channel.

According to an aspect, there is provided a computer readable medium comprising instructions which, when executed by an apparatus, cause the apparatus to perform at least the following: receiving, from a network node, a tracking reference signal comprising a first reference signal for a first channel and a second reference signal for a second channel, wherein the first channel is different to the second channel.

The instructions, when executed by the apparatus, may cause the apparatus to further perform: receiving, from the network node, a synchronization signal associated with the first reference signal.

The instructions, when executed by the apparatus, may cause the apparatus to further perform: determining a precoding applied to the synchronization signal; determining that the precoding applied to the synchronization signal is also applied to the first reference signal; and receiving the first reference signal based on the determined precoding.

The instructions, when executed by the apparatus, may cause the apparatus to further perform: determining one or more channel parameters associated with the synchronization signal; and receiving the first reference signal based on the determined one or more channel parameters.

The instructions, when executed by the apparatus, may cause the apparatus to further perform: determining that the first reference signal and the second reference signal have a quasi co-location relation with the synchronization signal; and receiving the first reference signal and the second reference signal based on the determined quasi co-location relation.

The instructions, when executed by the apparatus, may cause the apparatus to further perform: determining that the precoding applied to the first reference signal is also applied to the second reference signal; and receiving the second reference signal based on the determined precoding.

The instructions, when executed by the apparatus, may cause the apparatus to further perform: receiving, from the network node, information indicating one or more first configurations for the first reference signal and one or more second configurations for the second reference signal; receiving, from the network node, information indicating one or more activated tracking reference signal resource sets, wherein each tracking reference signal resource set corresponds to a combination of one of the one or more first configurations for the first reference signal and one of the one or more second configurations for the second reference signal, wherein receiving the tracking reference signal is based on the information indicating the one or more activated tracking reference signal resource sets.

The first reference signal and the second reference signal may be in the same time slot. The first reference signal and the second reference signal may have the same subcarrier allocation. The first reference signal and the second reference signal may have the same bandwidth. The first reference signal and the control channel may utilize a common search space. A bandwidth of the first reference signal may be based on a control resource set associated with the common search space. The first channel may be used to assign the second channel. The second channel may comprise broadcast information and/or system information. The first reference signal may comprise a first demodulation reference signal. The second reference signal may comprise a second demodulation reference signal. The first channel may comprise a control channel. The second channel may comprise a data channel.

According to an aspect, there is provided a computer readable medium comprising instructions which, when executed by an apparatus, cause the apparatus to perform at least the following: transmitting, to a user equipment, a tracking reference signal comprising a first reference signal for a first channel and a second reference signal for a second channel, wherein the first channel is different to the second channel.

The instructions, when executed by the apparatus, may cause the apparatus to further perform: transmitting, to the user equipment, a synchronization signal associated with the first reference signal.

The instructions, when executed by the apparatus, may cause the apparatus to further perform: transmitting, to the user equipment, information indicating one or more first configurations for the first reference signal and one or more second configurations for the second reference signal; transmitting, to the user equipment, information indicating one or more activated tracking reference signal resource sets, wherein each tracking reference signal resource set corresponds to a combination of one of the one or more first configurations for the first reference signal and one of the one or more second configurations for the second reference signal, wherein transmitting the tracking reference signal is based on the information indicating the one or more activated tracking reference signal resource sets.

The first reference signal and the second reference signal may be in the same time slot. The first reference signal and the second reference signal may have the same subcarrier allocation. The first reference signal and the second reference signal may have the same bandwidth. The first reference signal and the control channel may utilize a common search space. A bandwidth of the first reference signal may be based on a control resource set associated with the common search space. The first channel may be used to assign the second channel. The second channel may comprise broadcast information and/or system information. The first reference signal may comprise a first demodulation reference signal. The second reference signal may comprise a second demodulation reference signal. The first channel may comprise a control channel. The second channel may comprise a data channel.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows an illustration of an example tracking reference signal configuration;

FIG. 5a shows an exemplary illustration of downlink resource allocation for synchronization signal blocks, system information broadcast 1, and tracking reference signals;

FIG. 5b shows an example resource element grid for one of the slots of FIG. 5a comprising a tracking reference signal;

FIG. 6 shows example patterns for multiplexing synchronization signal block and control resource set #0;

FIG. 7 shows methods according to some examples;

FIG. 8 illustrates an example where a tracking reference signal comprises a combination of a first reference signal and a second reference signal;

FIG. 9 shows a signalling exchange according to some examples; and

FIG. 10, illustrates an example where a tracking reference signal comprises a combination of a first reference signal and a second reference signal and a further reference signal.

### DETAILED DESCRIPTION

A non-exhaustive list of some abbreviations used throughout the present disclosure is provided below for reference:

| | |
|---|---|
| CORESET | Control Resource Set |
| CSI | Channel State Information |
| DCI | Downlink Control Information |
| DMRS | Demodulation Reference Signal |
| FDM | Frequency Domain Multiplexing |
| MIMO | Multiple Input Multiple Output |
| NR | New Radio |
| PBCH | Physical Broadcast Channel |
| PDCCH | Physical Downlink Control Channel |
| PDSCH | Physical Downlink Shared Channel |
| PUCCH | Physical Uplink Control Channel |
| PUSCH | Physical Uplink Shared Channel |
| QCL | Quasi co-location |
| RE | Resource Element |
| RS | Reference Signal |
| SCS | Subcarrier Spacing |
| SSB | Synchronization Signal and PBCH Block |
| TDM | Time Division Multiplexing |
| TRS | Tracking RS |
| UE | User Equipment |

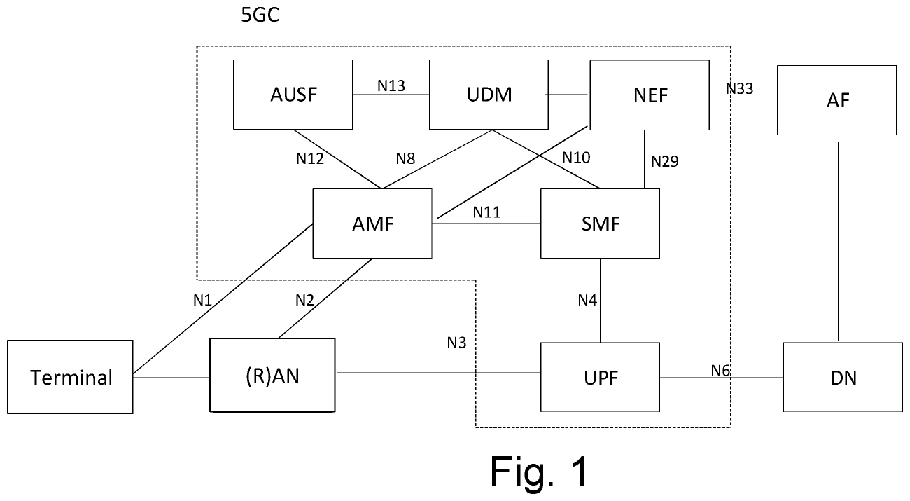

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions. The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF). FIG. 1 also shows the various interfaces (N1, N2 etc.) that may be implemented between the various elements of the system.

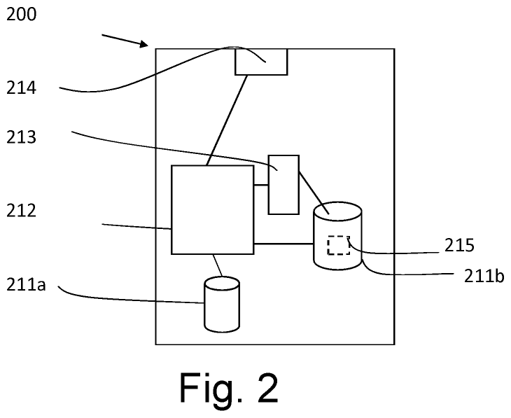

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

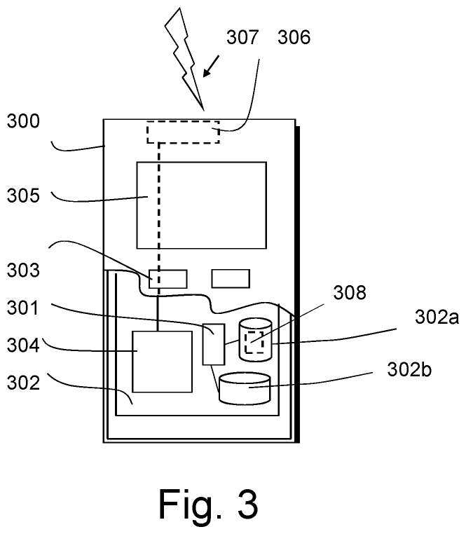

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

Examples of the present disclosure relate to tracking reference signals (TRSs). TRS is a signal transmitted from a base station to a UE. The UE may monitor the TRS for time and frequency domain parameter estimation to set the channel estimator parameters for the subsequent reception of the PDCCH, PDSCH and CSI-RS. Additionally or alternatively, the UE may monitor TRS to perform fine time and frequency synchronization tracking in the serving cell.

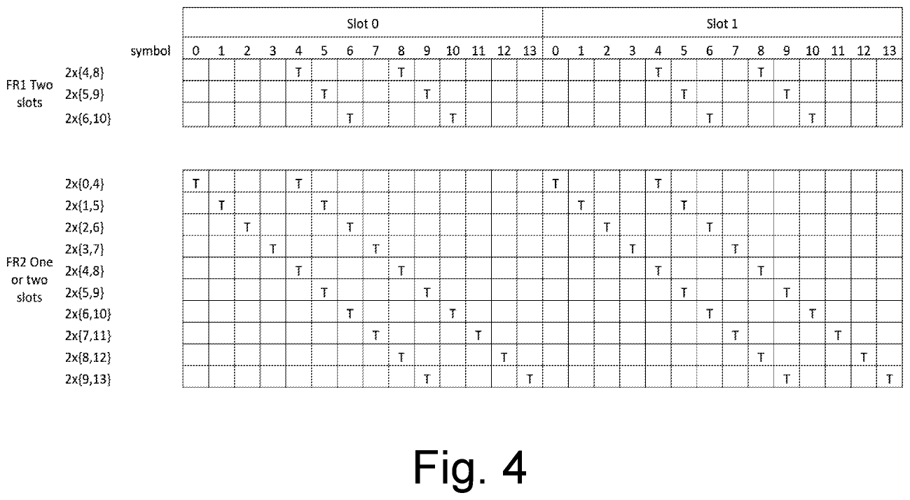

In some examples, TRS may be configured as one-port CSI-RS resource(s). The TRS burst length may be two consecutive valid downlink slots in FR1 and one or two consecutive valid downlink slots in FR2. There may be two TRS symbols in each TRS slot. TRS symbols in the slot may have four symbol separation. The TRS burst periodicity may be one of: 10, 20, 40 or 80 ms. An example illustration of such a TRS configuration is shown in FIG. 4, where the symbol slots marked “T” are symbol slots comprising a TRS symbol.

As can be seen from the example of FIG. 4, in FR1 the TRS burst length is two slots (slot 0 and slot 1), and in FR2 the TRS burst length is either one slot (slot 0 only), or two slots (slot 0 and slot 1). Each slot comprises two TRS symbols with four symbol separation. The specific position of each TRS symbol is given by the symbol index in brackets—for example {4,8} indicates that the TRS symbols are located in symbol indexes 4 and 8 within a slot. While FIG. 4 shows an example where TRS is allocated into symbols within a slot or consecutive slots, it should be understood that in some examples a different allocation to that shown in FIG. 4 is also possible.

The UE may be configured multiple TRS configurations to receive TRS and track time and frequency domain parameters for the channel estimators according to the multiple TRS configurations. In some examples, the different TRS configurations may correspond to TRS from different transmission points/TX beams.

In some implementations (for example according to 3GPP TS 38.214), the TRS may be periodic and UE specific. That is to say, TRS may be configured separately for each UE.

In some examples there may be additional aperiodic TRS. However the aperiodic TRS is associated with a periodic TRS. For example, a TRS may be periodic, where the TRS resources are configured with same periodicity, bandwidth and subcarrier location; or periodic with TRS resources in one set and aperiodic with TRS resources in a second set, with the aperiodic TRS and periodic TRS resource having the same bandwidth with same RB location.

In some examples, UEs in IDLE or INACTIVE mode may be configured to receive a common (i.e. not UE specific) TRS in order to update channel estimation filter parameters like average delay, delay spread, doppler shift and doppler spread. However the common TRS is not monitored by the UE and used for reception of CDI-RS, PDCCH and PDSCH.

In some examples the TRS may be a quasi co-location (QCL) reference signal, such as but not limited to a demodulation reference signal (DMRS). QCL may be understood as follows: two antenna ports are said to be quasi co-located if properties of the channel over which a symbol on one antenna port is conveyed can be inferred from the channel over which a symbol on the other antenna port is conveyed.

There may be different QCL types. A transmission configuration indication (TCI) state may be used to indicate a QCL type to the UE.

For example, 3GPP TS 38.214 defines four difference types of QCL as listed below.

TABLE 1
example QCL types and associated parameters

| QCL Type | Description |
|---|---|
| QCL-TypeA | Doppler shift, Doppler spread, average delay, delay spread |
| QCL-TypeB | Doppler shift, Doppler spread |
| QCL-TypeC | Average delay, Doppler shift |
| QCL-TypeD | Spatial Rx parameter |

When a signal A is QCLed with another signal B, the two signals A and B may experience very similar channel conditions. In order for A and B to be QCLed (i.e. go through the similar channel), it may be that the signals are sent are from the same location (i.e, same place and same antenna). In some examples, the signal A and B may be transmitted from the same transmission-reception point (e.g. Antenna Array) that applies the same Spatial Filter (beam). Since the two signals reaches the receiver through similar channel, if the receiver can detect one of the signal A and determine the channel properties of the signal A, the reception of the other signal B may be improved.

For instance, when the PDCCH from an access node (e.g. gNB) is QCLed with SSB, the PDCCH may experience a similar channel condition as SSB. The UE, when detecting SSB, may determine channel information, and may use the determined channel information to help detect PDCCH as well.

There may be different parameters used to define the channel condition, such as Doppler Shift, Doppler Spread, Average Delay, Delay Spread, and Spatial Rx Parameter. One or more of these parameters may define a property of the channel that two signal shares. Predefined groups of these parameters may be labelled as a QCL type (for example as shown in table 1 above).

The relationship of two related signals may for example be defined by the type—for example ‘The PDCCH signal from the gNB is QCLed with SSB via Type C’. In this example, the PDCCH and the SSB were transmitted through a similar radio channel sharing similar properties in terms of Average Delay and Doppler Shift.

In some examples, the UE may be configured with a CSI-RS resource in a non-zero point (NZP) CSI-RS Resource Set (NZP-CSI-RS-ResourceSet) without TRS information (trs-Info) and without a parameter set for repetition (repetition). In such cases, the UE may receive TCI from the network indicating a QCL type for the CSI-RS as one of the following:
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, where SS/PBCH block may have a PCI different from the PCI of the serving cell. The UE may assume center frequency, SCS, SFN offset are the same for SS/PBCH block from the serving cell and SS/PBCH block having a PCI different from the serving cell, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

In some examples, the UE may be configured to receive a DMRS of PDCCH without a list of downlink or joint downlink-uplink TCI states (dl-OrJoint-TCIStateList). In such cases, the UE may receive TCI from the network indicating a QCL type for the PDCCH as one of the following:
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-Resource Set configured without higher layer parameter trs-Info and without higher layer parameter repetition and, when applicable, ‘typeD’ with the same CSI-RS resource.

In some examples, the UE may be configured to receive a DMRS of PDSCH without di-OrJoint-TCIStateList. In such cases, the UE may receive TCI from the network indicating a QCL type for the PDSCH as one of the following:
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

As explained above, in some examples each UE in the system may be configured with UE specific TRS, which may be periodic. As a result, the system overhead may be relatively high. It may be beneficial if the system overhead due to periodic, UE specific TRS can be reduced.

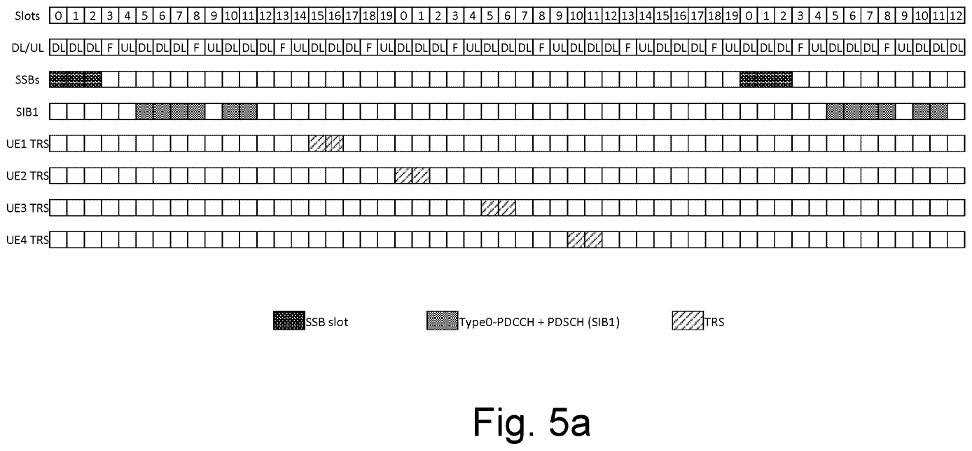

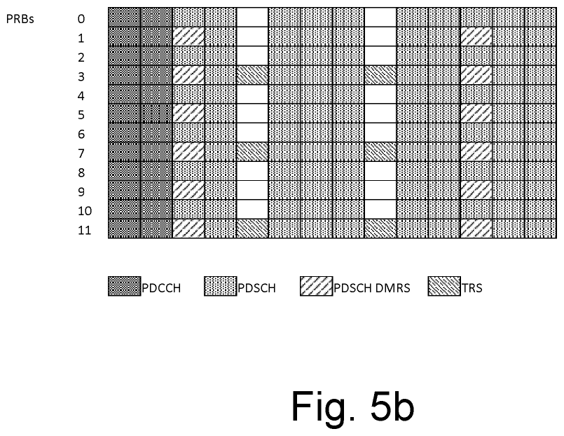

FIG. 5a shows an exemplary illustration of the DL resource allocation for the SSBs, SIB1 and TRSs to highlight the problem of system overhead. In the example of FIG. 5a, a 30 KHz subcarrier spacing (SCS) is assumed, with a slot duration of 0.5 ms. 6 Synchronization Signal and PBCH Blocks (SSBs) are provided, where the SSBs are mapped to three first slots every 20 ms. A Type0-PDCCH/PDSCH (SIB1) is transmitted per each SSB in a slot-based scheduling manner, i.e. there is Type0-PDCCH/PDSCH per SSB and per slot. FIG. 5b shows an example RE grid for one of the slots comprising a TRS.

It is also assumed that a hybrid beamforming architecture is implemented, requiring signals to different directions be transmitted in time division manner. That is to say, UE specific TRSs are transmitted to four different UEs/spatial directions in different slots.

As can be seen from the example of FIGS. 5a and 5b, as more UEs are added to the system, the network begins to run out of DL slots for data transmission due to having to schedule TRS in the DL slots. Furthermore, in some examples different TRSs (to different UEs) may use different transmission beams from an access node (e.g. gNB), and as such the access node may not be able to multiplex the TRSs together with another signal in the TRS symbol slots using frequency division multiplexing due to the access node having an analog beamforming component (e.g. as in FR2).

In some examples, the monitoring occasions of the Type0-PDCCH may be associated to the SSBs. In other words, each SSB may have associated Type0-PDCCH monitoring occasions. Type0-PDCCH may be understood as a common search space which conveys downlink control information (DCI) with cyclic redundancy check (CRC) bits scrambled by System Information Radio Network Temporary Identifier (SI-RNTI). The DCI may assign the PDSCH for System Information Block 1 (SIB1)—SIB1 may also be known as Remaining Minimum System Information (RMSI).

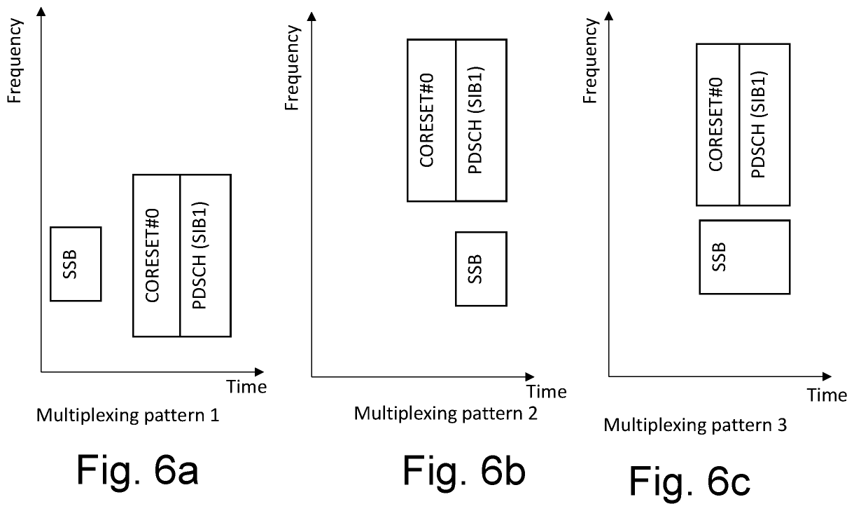

There may be different SSB/control resource (e.g. CORESET #0for Type0-PDCCH) multiplexing patterns. For example, FIG. 6 shows three example patterns for multiplexing SSB and CORESET #0.

CORESET may be understood as a set of physical resources (i.e. a specific area on the Downlink Resource Grid) that may be used to carry PDCCH/DCI. The set of RBs and the set of OFDM symbols in which the CORESET is located may be configurable with the corresponding PDCCH search spaces. CORESET #0 (aka CORESET0) may be understood as being a special CORESET used to transmit PDCCH for SIB1/RMSI. CORESET0 may be configured by MIB/PBCCH and may have one or more predefined values.

In pattern 1, shown in FIG. 6a, time division multiplexing (TDM) is applied. This pattern may be applicable in FR1 and FR2, with a monitoring occasion per SSB in two consecutive slots every 20 ms. In pattern 2, shown in FIG. 6b, different SCS may be applied SSB and CORESET #0, with frequency division multiplexing (FDM) applied. This pattern may be applicable in FR2, with one monitoring occasion and the same periodicity as SSB. In pattern 3, shown in FIG. 6c, the same SCS is applied for SSB and CORESET #0, with FDM applied. This pattern may be applicable in FR2, with one monitoring occasion and the same periodicity as SSB.

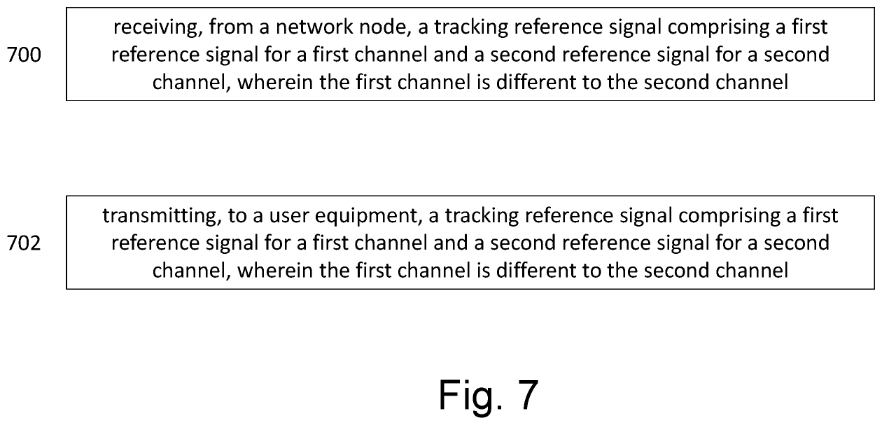

Reference is made to FIG. 7, which shows methods according to some examples.

At 700, a method comprises receiving, from a network node, a tracking reference signal comprising a first reference signal for a first channel and a second reference signal for a second channel, wherein the first channel is different to the second channel.

At 702, a method comprises transmitting, to a user equipment, a tracking reference signal comprising a first reference signal for a first channel and a second reference signal for a second channel, wherein the first channel is different to the second channel.

In some examples, a network node (e.g. a base station, such as but not limited to a gNB) sends, to a UE, a TRS comprising a first reference signal for a first channel and a second reference signal for a second channel.

The first channel may comprise a control channel. The second channel may comprise a data channel. The first channel may be different to the second channel. The first reference signal may comprise a demodulation reference signal (DMRS). The first reference signal may for example comprise a Type0-PDCCH DMRS. The second reference signal may comprise a DMRS. The second reference signal may for example comprise a PDSCH DMRS.

In the following examples, reference is made to a first DMRS and a second DMRS. It should be understood that in some examples a reference signal other than a DMRS may be used, and that references to a first DMRS and second DMRS are understood as encompassing a first RS and a second RS.

The first DMRS and the second DMRS may be in the same time slot. The first DMRS and the second DMRS may have the same subcarrier allocation. The first DMRS and the second DMRS may have the same bandwidth. The bandwidth of the TRS signal may be defined by the bandwidth of the first DMRS—for example the bandwidth of the TRS may be defined by the CORESET #0 of the Type0-PDCCH DMRS. The Type0-PDCCH DMRS may be a wideband DMRS, i.e. it may be allocated and transmitted across the whole CORESET #0 bandwidth.

The UE may assume that the same precoding is applied to the second DMRS as the precoding applied to the first DMRS. The UE may therefore assume that the same precoding may be applied for resource element patterns associated with the first DMRS and second DMRS.

The UE assume that the same precoding is applied to the first DMRS as the precoding applied to the to the synchronization signal (SSB), where the SSB is associated with the first DMRS.

The UE may assume that the associated SSB is a QCL source for the first DMRS—for example in terms of parameters such as average delay, doppler shift etc., the UE may estimate average delay and doppler shift from the SSB to set channel estimator filter(s) for the reception of the first DMRS.

The UE may assume that the first DMRS and the second DMRS have a quasi co-location relation with the SSB. The UE may receive the first DMRS and the second DMRS based on the determined quasi co-location relation—for example in terms of parameters such as average delay, doppler shift etc., the UE may estimate average delay and doppler shift from the SSB to set channel estimator filter(s) for the reception of the first DMRS and second DMRS.

The first DMRS and the control channel may utilize a common search space (e.g. CORESET #0 of the Type0-PDCCH). The common search space may be used to determine monitoring occasions and PDCCH candidates for common control signalling targeted to all UEs in the system. The bandwidth of the first DMRS may be determined based on a control resource set associated with the common search space. The first control channel may assign the data channel. The data channel may comprise broadcast information or system information (e.g. SIB1).

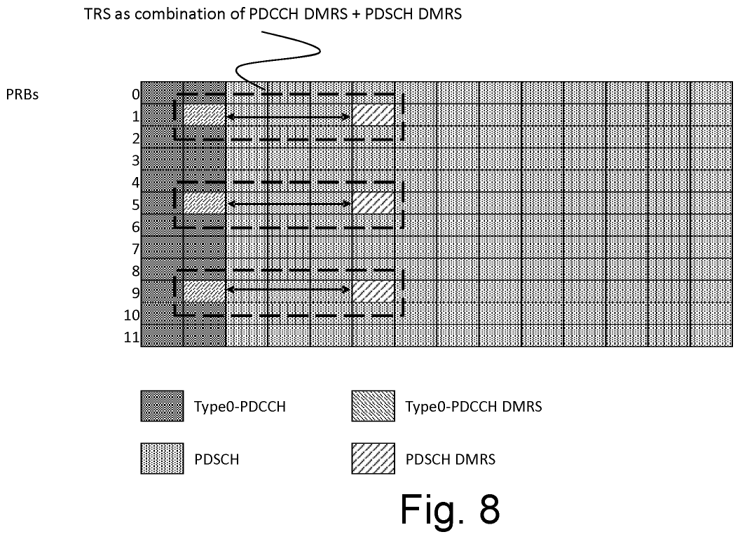

FIG. 8 illustrates an example where the TRS comprises a combination of a first DMRS (e.g. Type0-PDCCH DMRS and a second DMRS (e.g. PDSCH DMRS).

In some examples, aperiodic TRS may be triggered in addition to the TRS comprising the first DMRS and second DMRS. The TRS comprising the first DMRS and second DMRS may act as a QCL source for the aperiodic TRS. The aperiodic TRS may be transmitted using narrower beam than used for when a periodic TRS that is SSB based (i.e. not comprising a first DMRS and second DMRS) acts as the QCL source.

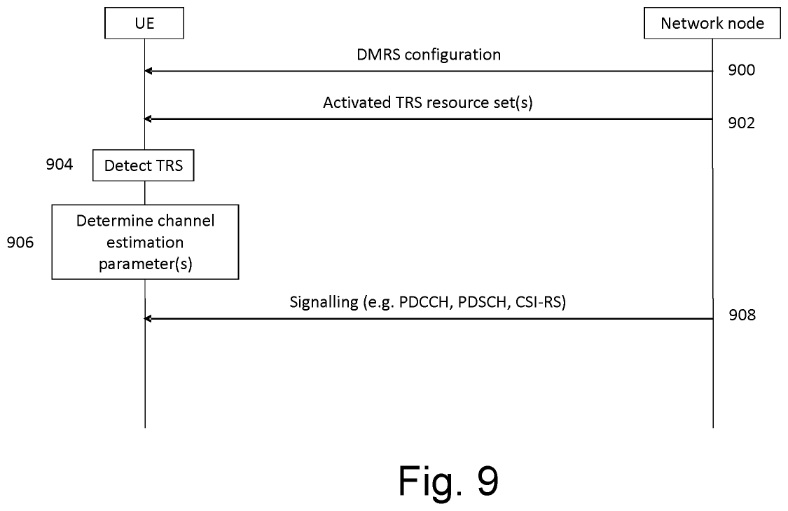

Reference is made to FIG. 9, which shows a signalling exchange according to some examples.

At 900, the network node (such as an access node, e.g. gNB) sends, to the UE, information indicating at least one first configuration for the first DMRS and at least one second configuration for the second DMRS. In some examples, the network node may send the information to a plurality of UEs served by the network node.

In some examples each configuration may define how at least one resource set (e.g. CORESET #0) is constructed (e.g. the time and frequency resources of the resource set).

Based on the configuration, the UE may determine how the DMRS for the resource set is allocated.

In some examples the UE may receive the information indicating the DMRS configurations via dedicated signaling.

At 902, the network node sends, to the UE, information indicating one or more configured/activated TRS resource set(s). The configured/activated TRS resource set(s) correspond to certain combinations of the first DMRS and second DMRS. In some examples, the network node may send the information to the plurality of UEs served by the network node

The information received at 902 may be received by the UE while the UE is in an RRC CONNECTED mode. Each TRS resource set may be indicated by an associated SSB. The associated SSB may act as a QCL source for the TRS resource set.

In some examples the network node may send the information indicating the one or more configured/activated TRS resource set(s) via a broadcast channel.

At 904, based on the information received at 900 and 902, the UE detects a TRS comprising the first DMRS and second DMRS.

At 906, based on the detected TRS, the UE determines one or more channel estimation parameters, such as but not limited to average delay, delay spread, doppler shift and doppler spread.

In some examples, steps 904 and 906 may be performed periodically. The periodicity may be indicated by the network node at step 900 and/or step 902. In some examples, the UE may assume a default periodicity, e.g. every 20 ms.

At 908, based on the determined one or more channel estimations, the UE may receive one or more signals from the network node. For example, the UE may receive one or more of: PDCCH, PDSCH and CSI-RS. The UE may for example set channel estimation filters for the reception of the one or more signals based on the determined one or more channel estimations.

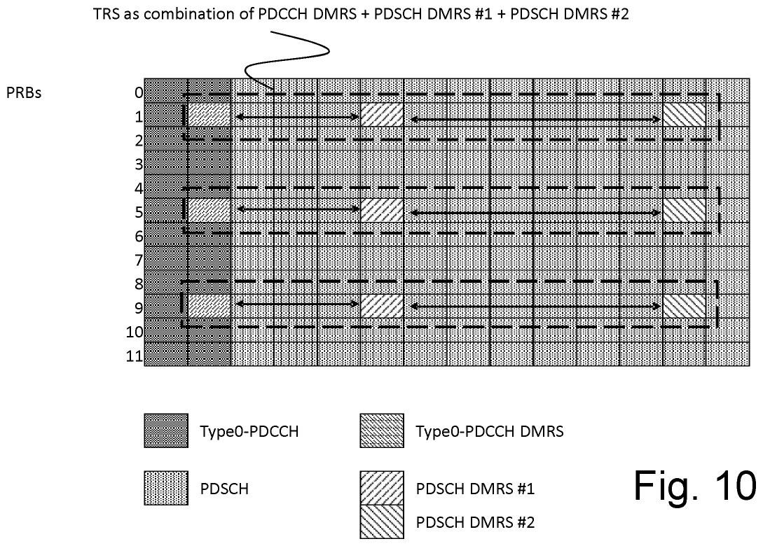

In some example implementations the TRS may comprise at least one further DMRS. The at least one further DMRS may for example comprise at least one further DMRS for a data channel. The provision of at least one further DMRS may enable the UE to determine channel estimation parameters, such as frequency offset, with different resolutions and ranges. In such examples, the information received by the UE from the network node at 900 may be adapted to further indicate at least one configuration for the at least one further DMRS, and the information received by the UE from the network node at 902 may be adapted to indicate configured/activated TRS resource set(s) corresponding to certain combinations of the first DMRS, second DMRS, and at least one further DMRS. This concept is illustrated in FIG. 10, where the TRS comprises a first DMRS for a control channel (e.g. Type0-PDCCH DMRS), second DMRS for a data channel (e.g. PDSCH DMRS #1) and at least one further DMRS (e.g. PDSCH DMRS #2).

Therefore in some examples a TRS may comprise a first DMRS for a control channel and a second DMRS for a data channel. By providing a TRS according to the examples described above, some examples may reduce system overhead as UE specific periodic TRS can be omitted—for example the TRS may be sent using a resource set shared by multiple UEs served by an access node, and so UE specific TRS may not be required. Some examples may be especially beneficial in case of high number of active UEs in the cell, as the system overhead reduction may be greater with increasing numbers of UEs.

In some examples, an apparatus may comprise means for: receiving, from a network node, a tracking reference signal comprising a first reference signal for a first channel and a second reference signal for a second channel, wherein the first channel is different to the second channel.

In some examples, the apparatus may comprise at least one processor and at least one memory storing instructions that, when executed by the at least one processor, cause the apparatus at least to: receive, from a network node, a tracking reference signal comprising a first reference signal for a first channel and a second reference signal for a second channel, wherein the first channel is different to the second channel.

In some examples, an apparatus may comprise means for: transmitting, to a user equipment, a tracking reference signal comprising a first reference signal for a first channel and a second reference signal for a second channel, wherein the first channel is different to the second channel.

In some examples, the apparatus may comprise at least one processor and at least one memory storing instructions that, when executed by the at least one processor, cause the apparatus at least to: transmit, to a user equipment, a tracking reference signal comprising a first reference signal for a first channel and a second reference signal for a second channel, wherein the first channel is different to the second channel.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising at least one processor and at least one memory storing instructions that, when executed by the at least one processor, cause the apparatus at least to perform:
receiving, from a network node, a tracking reference signal comprising a first reference signal for a first channel and a second reference signal for a second channel, wherein the first channel is different to the second channel.

2. The apparatus of claim 1, wherein the apparatus is further caused to perform:
receiving, from the network node, a synchronization signal associated with the first reference signal.

3. The apparatus of claim 2, wherein the apparatus is further caused to perform:
determining a precoding applied to the synchronization signal;
determining that the precoding applied to the synchronization signal is also applied to the first reference signal; and
receiving the first reference signal based on the determined precoding.

4. The apparatus of claim 3, wherein the apparatus is further caused to perform:
determining one or more channel parameters associated with the synchronization signal; and
receiving the first reference signal based on the determined one or more channel parameters.

5. The apparatus of claim 2, wherein the apparatus is further caused to perform:
determining that the first reference signal and the second reference signal have a quasi co-location relation with the synchronization signal; and
receiving the first reference signal and the second reference signal based on the determined quasi co-location relation.

6. The apparatus claim 1, wherein the apparatus is further caused to perform:
determining that the precoding applied to the first reference signal is also applied to the second reference signal; and
receiving the second reference signal based on the determined precoding.

7. The apparatus of claim 1, wherein the apparatus is further caused to perform:
receiving, from the network node, information indicating one or more first configurations for the first reference signal and one or more second configurations for the second reference signal;
receiving, from the network node, information indicating one or more activated tracking reference signal resource sets, wherein each tracking reference signal resource set corresponds to a combination of one of the one or more first configurations for the first reference signal and one of the one or more second configurations for the second reference signal,
wherein receiving the tracking reference signal is based on the information indicating the one or more activated tracking reference signal resource sets.

8. An apparatus comprising at least one processor and at least one memory storing instructions that, when executed by the at least one processor, cause the apparatus at least to perform:
transmitting, to a user equipment, a tracking reference signal comprising a first reference signal for a first channel and a second reference signal for a second channel, wherein the first channel is different to the second channel.

9-10. (canceled)

11. The apparatus of claim 1, wherein the first reference signal and the second reference signal are in the same time slot.

12. The apparatus of claim 1, wherein the first reference signal and the second reference signal have the same subcarrier allocation.

13. The apparatus of claim 1, wherein the first reference signal and the second reference signal have the same bandwidth.

14. The apparatus of claim 1, wherein the first reference signal and the control channel utilize a common search space.

15. The apparatus of claim 14, wherein a bandwidth of the first reference signal is based on a control resource set associated with the common search space.

16. The apparatus of claim 1, wherein the first channel is used to assign the second channel.

17. The apparatus of claim 1, wherein the second channel comprises broadcast information and/or system information.

18. The apparatus of claim 1, wherein the first reference signal comprises a first demodulation reference signal.

19. The apparatus of claim 1, wherein the second reference signal comprises a second demodulation reference signal.

20. The apparatus of claim 1, wherein the first channel comprises a control channel.

21. The apparatus of claim 1, wherein the second channel comprises a data channel.

22-23. (canceled)

24. A method comprising:
receiving, from a network node, a tracking reference signal comprising a first reference signal for a first channel and a second reference signal for a second channel, wherein the first channel is different to the second channel.

25. (canceled)
